(19) United States
(12) Patent Application Publication
(10) Pub. No.: US 2013/0238465 A1
(43) Pub. Date: Sep. 12, 2013

(54) SYSTEMS AND METHODS FOR TARGETED GIFTING

(71) Applicants: Frantz Calixte-Civil, Kendall Park, NJ (US); Herby Bercy, West Orange, NJ (US)

(72) Inventors: Frantz Calixte-Civil, Kendall Park, NJ (US); Herby Bercy, West Orange, NJ (US)

(21) Appl. No.: 13/415,715

(22) Filed: Mar. 8, 2012

(51) Int. Cl. G06Q 30/06

(52) U.S. Cl. 705/26.41

(57) ABSTRACT

Systems and methods for targeted gifting are presented herein. In some embodiments, a giftee (i.e., gift recipient) provides, to a computer system, one or more gift selections and a gift rank set, where each gift rank indicates a giftee's preference for receiving the associated gift selection over other gift selections. A giftor (i.e., gift giver), in turn, may provide, one or more gift criteria defining parameters under which the giftor is willing (or able) to purchase a gift for the giftee (e.g., a purchasing budget). Using the gift selections, associated gift ranks, and the gift criteria, a target gift set may be selected from the gift selection set, and items from the target gift set may be acquired for the giftee on behalf of the giftor. Operations performed in some embodiments may be automatic and in accordance with gift-giving occasions (e.g., in advance of calendared events, such as birthdays).

### BACKGROUND

1. Technical Field

The present invention(s) generally relate to gifting and, more particularly, relate to systems and methods for gifting based on the preferences and criteria of those giving a gift (i.e., giftors) and/or those receiving a gift (i.e., giftees).

2. Description of Related Art

The practice of giving and receiving gifts is a well-known and common place tradition, associated with a number of personal and traditional gift-giving occasions. Certain gift-giving occasions are constantly reoccurring, such as birthdays, anniversaries, Christmas, and Valentine's Day. Others are less common place and usually associated with important life events, such as weddings, baby showers, and graduations.

Generally, over time, the number of gift-giving occasions an individual wants or needs to remember tends to increase. In addition to remembering gift-giving occasions, often giftors must also concern (and inconvenience) themselves with obtaining a gift in time for such occasions, and choosing a gift that is appropriate for the gift recipient and/or the occasion. Some of these concerns have been eased with the introduction of calendar reminders, gift registries, and wish lists. Typically, a gift registry is populated by one or more gift recipients, linked with a particular retailer, and associated with a particular gift-giving occasion (e.g., wedding registry, baby shower). In contrast, a wish list (also referred to as, “product wish list” or “gift wish list”) may be associated with a particular retailer or gift-giving occasion, but usually serve the general purpose of tracking items (e.g., products or services) that an individual desires for his or herself, either as a gift or through their own purchase. With the introduction of the Internet, giftor access to such gift registries and wish lists has been made both easier and ubiquitous, especially with respect to retailers having an online presence.

### SUMMARY OF EMBODIMENTS

Systems and methods for gift giving are discussed herein. Various embodiments provide for automated selection and acquisition of a gift for a gift recipient (also referred to herein as a “giftee”) on behalf of a gift giver (also referred to herein as a “giftor”).

An exemplary method comprises receiving a set of gift selections (also referred to herein as a “gift selection set”), which provides a listing of gifts a giftee would prefer to receive or purchase for his or herself, and set of gift ranks (also referred to herein as a “gift rank set”), which provides an order of preference for the list of gifts. Accordingly, in some embodiments, each gift rank in the gift rank set may correspond to at least one particular gift selection in the gift selection set and indicate a giftee's preference for receiving the corresponding gift selection. For some embodiments, the gift selection set and the gift rank set may be associated with more than one giftee, and may be associated with one or more gift giving occasions. Additionally, depending on the embodiment, the gift selection set and the gift rank set may be determined (i.e., created or setup) by a giftee (e.g., import in giftee's gift registry from an online retailer) or by a giftor (e.g., where giftor creates a gift wish list based on his or her knowledge of the giftee). The method further comprises receiving a set of gift criteria (also referred to herein as a “gift criterion set”), which provides a giftors preferences in choosing a gift for a giftee. Accordingly, the gift criterion set is generally determined (i.e., created or setup) by a giftor. The method may further comprise selecting target gift set from the gift selection set based on the gift criterion set and the gift rank set, and assisting in fulfilling (e.g., acquiring) a gift selection (also referred herein as an “item”) in the target gift set in accordance with a set of acquisition preferences (also referred to herein as a “acquisition preference set”) of the giftors.

An exemplary system comprises a gift selection module, a gift scanning module, and a gift fulfillment module, with at least one of the modules operates on a computer system. The gift selection module may be configured to receive a gift selection set and a gift rank set associated with the gift selection set, which may be of a giftee or a giftee. The gift scanning module may be configured to receive a gift criterion set, possibly of a giftor, and select a target gift set from the gift selection set based on the gift criterion set and the gift rank set. The gift fulfillment module may be configured to assist in fulfilling a gift selection in the target gift set for a gift recipient on behalf of the giftor.

In particular embodiments, the gift criterion set may include a budget, a product manufacturer, a product model, a product category, a retailer, or a shipping option. The gift criterion set may be associated with a particular gift recipient, a plurality of gift recipients, a particular occasion, or a plurality of occasions. For example, the gift criterion set may be associated with a birthday for a giftee and, as such, include criteria related thereto. In another example, a gift criterion set may be associated with a giftor's wedding anniversary and, as such, may include such criteria as a budget of $500 dollars, a giftor's preference to purchase jewelry, or a giftor's preference to purchase the gift from one or more specific outline retailers, such as Amazon® or Blue Nile®.

In regard to assisting in fulfilling (e.g., acquiring) items within the target gift set, the acquisition preference set may include a shipment parameter, a retailer parameter, a packaging parameter, a gift accessory parameter, or a payment method parameter. In some embodiments, a gift selection for the giftee may include products or services, and may also include donations made by the giftor in the name of the giftee. Additionally, upon successful fulfillment of one or more items within the target gift set, some embodiments may update the gift selection set (e.g., remove successfully fulfilled items from the gift selection set) upon confirmation of fulfillment (e.g., confirmation from a fulfillment system that the item has been ordered or delivered). For some embodiments, where some or all of the items in the gift selection set are imported from a third-party gift registry or wish list, updates to the gift selection set may result in updates to the third-party gift registry or wish list. For example, where an item in the gift selection set is removed from the gift selection set upon fulfillment (e.g., successful order or delivery), such removal may be similarly applied to the gift registry or wish list from which the item was originally imported.

In various embodiments, selecting the target gift set may comprise: identifying a first subset of gift selections (also referred to herein as a “gift selection subset”) from the gift selection set based on the gift rank set; verifying whether the first gift selection subset meets the gift criterion set; and if the first gift selection subset meets the gift criterion set, selecting the first gift selection subset as the target gift set. If the first gift selection subset fails to meet the gift criterion set, a next gift selection subset may be identified from the gift selection set based on the gift rank set. Thereafter, the next gift selection subset may be verified to determine whether the next gift selection subset meets the gift criterion set. The operations of identifying and verifying another gift selection subset may be repeated until a gift selection subset meets the gift criterion set or all unique subset combinations for the gift selection set are exhausted.

In some embodiments, selecting the target gift set may comprise: identifying one or more subsets of the gift selections from the gift selection set; determining a rank score for each gift selection subset based on the gift rank set; determining a criterion score for each gift selection subset based on whether the gift selection subset meets the gift criterion set; and selecting a target gift set, from the gift selection subsets, having a rank score and a criterion score that result in an optimal score. For some embodiments, the optimal score may be the highest score relative or lowest score relative to the score of other gift selection subsets.

Certain embodiments may determine that a gift selection in a gift selection subset meets a gift criterion of the gift criterion set if the gift selection falls within a range based on the gift criterion. For instance, where the gift criterion is a budget, an upper limit of the range is equal to the budget, and a lower limit of the range is a value less than the budget. Exemplary lower limits may fall between 80 and 85% of the budget.

Depending on the embodiment, selection of the target gift set may be performed at a predetermined time in advance of a particular occasion associated with the gift recipient (e.g., a week or two weeks before a gift-giving occasion, or according to a static or reoccurring schedule). In addition, various embodiments may provide for targeted gifting from a single giftor to a single giftee, a single giftor to multiple giftees, or multiple giftors to a single giftee.

As noted herein, the gift selection set may be associated with a particular gift recipient, a plurality of gift recipients, a particular occasion, or a plurality of occasions. For example, the gift selection set may be a gift registry related to a baby shower for giftee A. Furthermore, the gift selection set may be imported from one or more third-party gift registries, one or more third-party wish lists, or some combination thereof. For instance, the gift selection set related to Christmas gifts for giftee A may be imported from a Christmas wish list setup by giftee A at an online retailer (i.e., a third-party wish list). In another example, a gift selection set related to a wedding for giftees A and B may be imported from wedding registries setup by giftee A or B, with multiple online retailers.

For some embodiments, the operations described herein may be implemented using a computer system. For example, a non-transitory computer readable medium may comprise executable instructions that cause a processor to perform various operations described herein.

### BRIEF DESCRIPTION OF THE DRAWINGS

FIG. 1 depicts an exemplary system for targeted gifting in accordance with some embodiments.

FIG. 2 depicts an exemplary system for targeted gifting in accordance with some embodiments.

FIG. 3 depicts a flowchart illustrating an exemplary method for targeted gifting in accordance with some embodiments.

FIG. 4 depicts a flowchart illustrating an exemplary method for targeted gifting in accordance with some embodiments.

FIG. 5 depicts a flowchart illustrating an exemplary method for targeted gifting using a scoring scheme in accordance with some embodiments.

FIG. 6 depicts an outcome for performance of an exemplary method for targeted gifting using a scoring scheme in accordance with some embodiments.

FIG. 7 is block diagram illustrating an exemplary digital device for implementing various embodiments.

### DETAILED DESCRIPTION OF EMBODIMENTS

In various embodiments, a giftee provides, to a computer system, one or more gift selections and a gift rank set, where each gift rank indicates a giftee's preference for receiving the associated gift selection over other gift selections. A giftor, in turn, may provide, one or more gift criteria defining parameters under which the giftor is willing (or able) to purchase a gift for the giftee (e.g., a purchasing budget). Using the gift selections, associated gift ranks, and the gift criteria, a target gift set may be selected from the gift selection set, and items from the target gift set may be acquired for the giftee on behalf of the giftor. Performance of operations in accordance with embodiments may be automatic and in accordance with gift-giving occasions (e.g., in advance of calendared events, such as Valentine's Day and birthdays). Additionally, the gift selection set utilized may be associated with a particular gift recipient, a particular calendared event, or both. Exemplary sets of gift selections may include gift registries or wish lists.

Various embodiments may be implemented as a network-based and automated gifting system, possibly owned and/or operated by an online gift retailer or service provider. For some embodiments, the network-based system may be implemented through a website and a web-interface, or an through an application, operating on a computing device, which interacts with the system over a network. Some embodiments may automatically match a giftor's budget to a giftee's gift wish list, select a gift, and have the gift sent in time for particular gift-giving occasions. Use of such embodiments not only helps busy and/or forgetful individuals (i.e., giftors) remember gift-giving occasions for individuals of interest (i.e., giftees), but also assists them in having a gift ready in time for such gift-giving occasions.

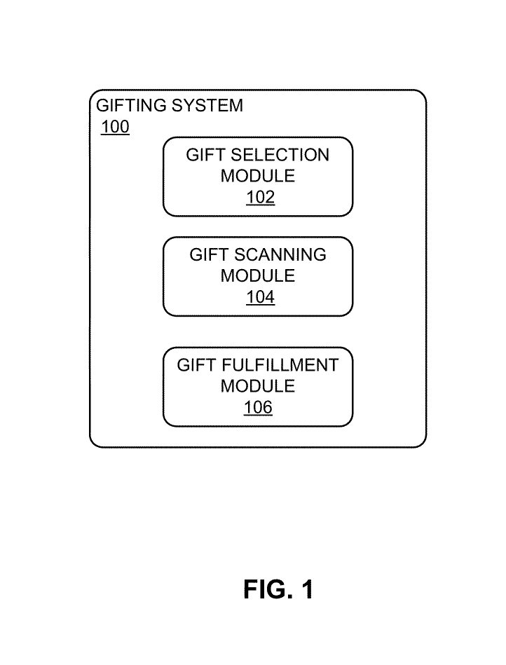

FIG. 1 depicts an exemplary system 100 for targeted gifting in accordance with some embodiments. The gifting system 100 comprises a gift selection module 102, a gift scanning module 104, and a gift fulfillment module 106. Various embodiments may implement the system 100 using a computer system.

The gift selection module 102 may be configured to receive a gift selection set comprising items a giftee may desire to receive as a gift, or a giftee may desire to purchase for his or herself. As noted herein, the items in the gift selection set may include products, services, or donations. Depending on the embodiment, the gift selection set may originate from a variety of sources. In some embodiments, a giftee may directly create the gift selection set through an interface of the gifting system 100, possibly provided by the gift selection module 102. In addition, the gift selection set may be created through the importation of a third-party gift registry or wish list (e.g., from an online retailer) into the gifting system 100. Further, the gift selection set may be dynamically generated by the gifting system 100 (e.g., automatic recommendations based on an existing gift selection set), or created through an amalgamation of existing sets of gift selections. The items in the gift selection set may include items available from the operator/owner of the gifting system 100 or available from one or more third-party retailers.

The system 100 may further comprise a gift browser module (not shown), accessible by a giftee or giftor and configured to present the giftee or giftor with gifts of relevance to the user. The gifts presented may be those available from a third-party retailer (e.g., Amazon®), those available from the system operators own warehouse/store, or both. In some embodiments, the gift browser module may be accessed by a giftor or giftee through a web-interface. With respect to a giftee, the gift browser module may be configured to present gift suggestions to a giftee based on items already in a gift selection set associated with the giftee (and accessible by the system 100). From the gifts presented, a giftee may easily select and add gifts shown through the gift browser module, to a gift selection set associated with the giftee (e.g., giftee's birthday gift selection set).

With respect to a giftor, the gift browser module may present gift suggestions to the giftee based on the chronology of gift-giving events, the giftee's associated with those events, and the gift selection sets associated with those events and/or giftees. Take, for instance, where Person A's birthday is May 1st, the giftor's and Person B's wedding anniversary is May 2nd, and Person C's house warming party is May 3rd. When a giftor reviews gift listings through the gift browser module (e.g., giftor navigates to “SHOP OCCASIONS” page through the system's web-interface), the first set of gifts presented may be from Person A's birthday gift selection since it is the first upcoming event, the next set of gifts may be from Person B's anniversary gift selection set, and the next set of gifts may be from Person C's general gift selection set. For some embodiments, as the gift items are presented to the giftor through the gift browser module, the association of those gift items with the gift-giving event, the giftee, or the gift selection set may be displayed or, alternatively, transparent to the giftor. Where the associations are transparent, the gifts presented to the giftor may appear the same as any typical ecommerce website. Through the gift browser module, a giftor may have the option to just navigate to the specific gift recipient.

In various embodiments, the gift selection set may be associated with one or more giftees, and may be further associated with a particular gift-giving occasion in connection with those giftees. For example, the gift selection set may be associated with the giftor's wife irrespective of the gift-giving occasion. In another example, a gift selection set may be associated with a giftor's wife, and may be further associated with the birthday of the giftor's wife. In a further example, the gift selection set may be associated with a giftor's coworkers, and may be further associated with the coworkers in connection to Christmas (e.g., Christmas gift list for coworkers). In some embodiments, the gift selection set may be generally associated with an occasion irrespective of the giftee to receive the gift. For instance, the gift selection set may be associated with Christmas regardless of the attended giftee.

In some embodiments, the gift selection set may be stored on, and subsequently retrieved from, a local database or datastore coupled to the gifting system 100. Accordingly, during operation, the gifting system 100 may retrieve (i.e., receive) the gift selection set from such a database or datastore. In some embodiments, the gifting system 100 may retrieve the gift selection set from a gift registry or wish list stored on a third-party system, such as that of an online retailer (e.g., Amazon®).

The gift selection module 102 may be further configured to receive a gift rank set associated with the gift selection set. Each gift rank may correspond to a particular gift selection in the gift selection set and indicates a giftee's preference for receiving the corresponding gift selection. In some embodiments, the gift rank set may be inherent to the gift selection set. For instance, the gift selection set may be a list of gift selections where the order of gift selections in the list indicates the gift rank. In various embodiments, the gift rank set may comprise a numerical value that indicates the importance of (and therefore the giftee's preference for) a corresponding gift selection in the gift selection set.

The gift rank set may be determined (i.e., setup) by a giftee through an interface to the gifting system 100, which may be implemented by the gift selection module 102. Additionally, in some embodiments, the gift selection set may be stored on, and subsequently retrieved from, a local database or datastore coupled to the gifting system 100. Accordingly, during operation, the gifting system 100 may retrieve (i.e., receive) the gift rank set from such a database or datastore. In some embodiments, the gifting system 100 may retrieve the gift rank set, along with the gift selection set, from a gift registry or wish list stored on a third-party system, such as that of an online retailer.

Though the gift selection set and the gift rank set are described herein as being the determined by a giftee, those skilled in the art will appreciate that in some embodiments, the gift selection set or the gift rank set may be setup or modified by the giftor. Take for instance where a giftee's gift selection set is not available to the gifting system 100 (e.g., it is on an incompatible third-party system, or the giftee has never bothered to set one up), but the giftor has learned of (or knows of) the giftee's gift preferences. In such an instance, the giftor may setup a gift selection set for the giftee well in advance of a gift-giving occasion.

The gift scanning module 104 may be configured to receive a gift criterion set determined by a giftor. The gift criterion set may include such criteria as a budget, a product manufacturer, a product model, a product category, a retailer, or a shipping option. As also described herein, the gift criterion set determined by the giftor may be associated with a particular gift recipient, a plurality of gift recipients, a particular occasion, or a plurality of occasions. For instance, the gift criterion set may be associated with Christmas gifts for coworkers, and may include such criteria as a budget of $25 dollars for each coworker, a giftor's preference to purchase Christmas-themed gifts, and a giftor's preference to purchase the gifts from a retailer that allows for local pick up service, such as Wal-Mart®. In another example relating to the birthday of a giftor's child, the gift criterion set may include such criteria as a budget of $300 and the giftor's preference to purchase a product manufactured by Apple®.

The gift criterion set may be determined (i.e., setup) by a giftor through an interface to the gifting system 100 (e.g., into the gift scanning module 104), which permits a giftor to create and modify the gift criterion set. The gift criterion set may be stored on, and subsequently retrieved from, a local database or datastore coupled to the gifting system 100. Accordingly, during operation, the gifting system 100 may retrieve (i.e., receive) the gift criterion set from such a database or datastore. In some embodiments, a giftor may have several gift criterion sets stored with the gifting system 100, with each gift criterion set being associated with one or more giftees, and may be further associated with a particular gift-giving occasion in connection with those giftees. In various embodiments, the gifting system 100 may be configured to match a gift criterion set with an appropriate gift selection set based on their associations with one or more giftees and with gift-giving occasions.

To further facilitate the setup of the gift selection set, the gift rank set, or the gift criterion set, and their association to one or more giftees or gift-giving occasions, the gifting system 100 may comprise contact list features, calendar features, social media integration features, or enterprise integration features. For instance, with use of contact list features, a giftor may import into the gifting system 100 contact information from such sources as a laptop, desktop computer, mobile device, an online service (e.g., online e-mail service), and the like. Such contact information may be utilized during acquisition/ordering of items in the target gift set (e.g., mailing address for delivery of items to giftee). In a further example, a giftor or giftee may use social media integration features to import contact information from a social media source, or may use enterprise integration features to import contact information from an enterprise database/directory (e.g., Active Directory or LDAP).

In another example, through the social media integration, a giftor or giftee may import Likes/Wants and/or product lists from social media services, such as Facebook® or Pinterest, into the system 100. For instance, if a giftee Likes a particular pair of shoes (e.g., by a particular designer) in their Facebook® profile, the system 100 may import that like, scan a listing of products available to the system 100 for ordering (e.g., through the operator's own store or through a third-party retailer), identify a match pair of shoes (either exact or closest match), and add the matching pair of shoes the giftee's gift selection set. Depending on the embodiment, the process of identifying/matching an item in the listing of products, available to the system 100, with an item from a giftee's social media site may be facilitated through a text description and/or an image matching process.

With use of calendar features, a giftor or giftee may review on the gifting system 100 and add one or more gift-giving occasions to the gifting system 100. Use of the calendar features may permit a giftor or giftee in creating associations between gift-giving occasions and the various sets used in the gifting system 100 (e.g., gift selection sets, gift rank sets, or gift criterion sets). Likewise, social media integration features may permit a giftor or giftee to import a giftee's wish list or a giftee's posted likes/dislikes from a social media source, which can be used in the setup of a gift selection set, a gift rank set, or a gift criterion set. Social media integration feature may further permit a giftor or giftee to import a calendar or dates for gift-giving occasions (e.g., wedding anniversary, or birthday) from the social media source into the gifting system 100.

The gift scanning module 104 may be configured to select a target gift set from the gift selection set, based on the gift criterion set and the gift rank set described herein. For some embodiments, the target gift set selection process may involve scanning through one or more sets of gift selections in view of the gift criterion set determined by the giftor, and in view of the gift ranks (e.g., determined by the giftee), and selecting the target gift set from the gift selections scanned.

In particular embodiments, the selection process may involve identifying a first gift selection subset from the gift selection set based on the gift rank set, and subsequently verifying whether the first gift selection subset meets the gift criterion set. Where the first gift selection subset meets the gift criterion set, the gift scanning module 104 may select the first gift selection subset as the target gift set. Inversely, where the first gift selection subset fails to meet the gift criterion set, a next gift selection subset may be identified from the gift selection set based on the gift rank set, and verified to determine whether the next gift selection subset meets the gift criterion set. In some embodiments, the operations of identifying and verifying another (i.e., next) gift selection subset may continue to repeat until (a) a gift selection subset meets the gift criterion set, or (b) all unique subset combinations possible from the gift selection set are exhausted.

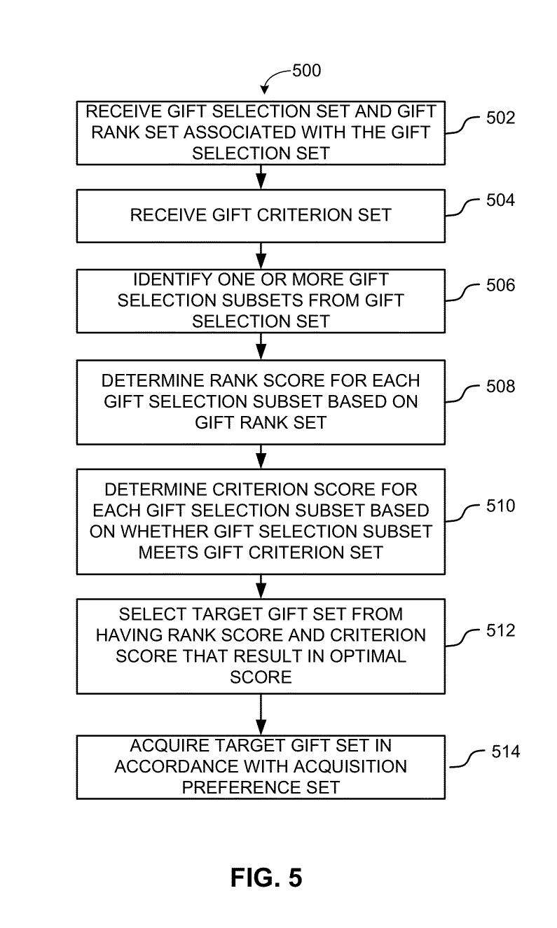

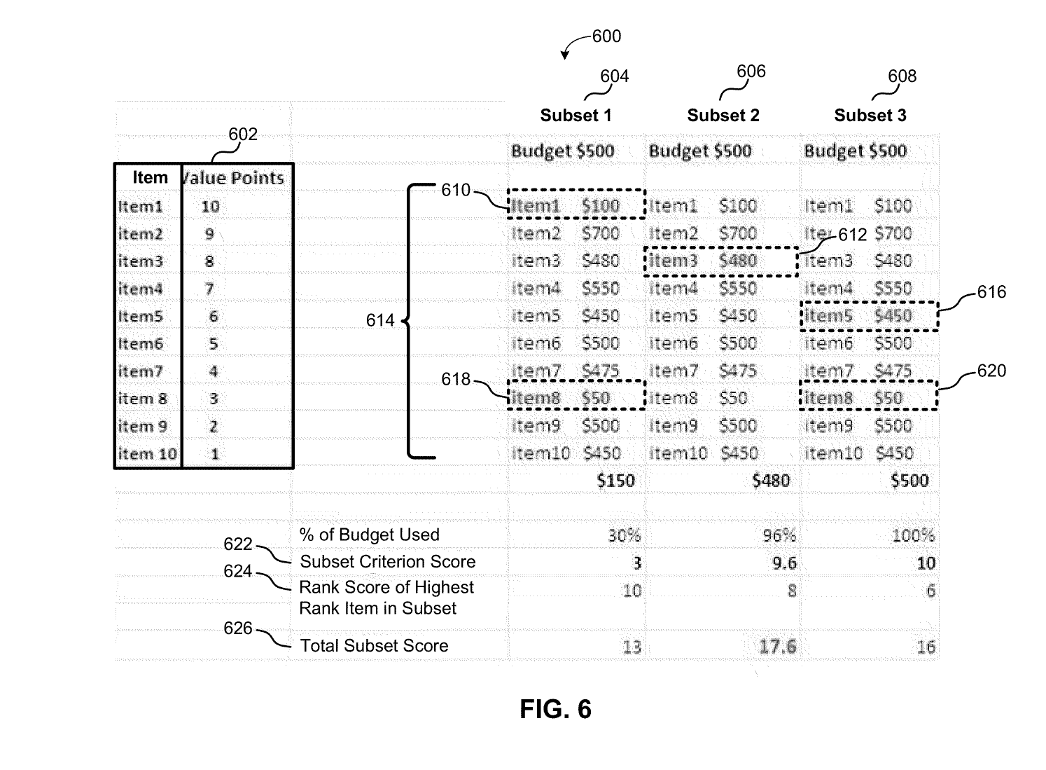

In various embodiments, the selection process may involve a scoring scheme, where the selection process may comprise generating one or more subsets of the gift selections from the gift selection set, determining a rank score for each gift selection subset based on the gift rank set, and determining a criterion score for each gift selection subset based on whether the gift selection subset meets the gift criterion set. Thereafter, based on the rank score and criterion score calculated for each gift selection subset, the selection process identifies those one or more gift selection subsets that result in an optimal score. For example, based on the sum of the rank score and the criterion score for each gift selection subset, the optimal score may be the highest score observed for the gift selection subsets, or may be the lowest score observed for the gift selection subsets. More regarding selection processes involving scoring will be described in connection with FIGS. 5 and 6.

The gift fulfillment module 106 may configured to acquire the target gift set for a gift recipient on behalf of the giftor, wherein the acquisition is in accordance with an acquisition preference set of the giftor. To execute (i.e., fulfill) the acquisition of the target gift set for the giftee on behalf of the giftor, the fulfillment module may generate and submit an order for each of the items within the target gift set. Depending on the item being acquired, and possibly the acquisition preference set defined by the giftor, the order by the gift fulfillment module 106 may be submitted to one or more fulfillment systems accessible by the gifting system 100.

For example, the operator/owner of the gifting system 100 may supply items in the target gift set from its own inventory and, as such, the gifting system 100 may generate and submit an order to a local fulfillment system, which may be co-located at the operator/owner's distribution and fulfillment warehouse (i.e., operator/owner's own store). In another example, the gifting system 100 may generate and submit orders for each item in the target gift set to one or more third-party retailers, possibly based on the giftor's acquisition preference set or based on availability of certain items with particular retailers. The gift system 100 may interface with a fulfillment system (third-party or otherwise) via socket communications over a network, or network-enabled application program interfaces (APIs).

The acquisition preference set determines parameters under which one or more items within the target gift set are acquired for the giftee on behalf of the giftor. Parameters contained in the acquisition preference set may include, for example, a shipment parameter, a retailer parameter, a packaging parameter, a gift accessory parameter, or a payment parameter. The parameters may also include the giftor's preferred methods of notification regarding the fulfillment of the target gift set. Exemplary methods of notification may include automated phone call, e-mail, or text message. For some embodiments involving an in-car audio, video, or navigation system, the method of notification may comprise delivering an audio (e.g., voice notification), visual, or textual notification (e.g., message) to a vehicle occupant through the in-car system.

An example of a shipment parameters may be the giftor's preference that the items in the target gift set be sent directly to the giftor (rather than the giftee) in advance of a gift-giving occasion, thereby allowing the giftor to personally deliver the gift to the giftee. Another example of a shipment parameter may include shipping the items in the target gift set at a predetermined time before the gift-giving occasion (e.g., one week, three day, etc.). With respect to retailer parameters, examples may include the giftor's designations of one or more specific third-party retailers from which items in the target gift set should be purchased, and may also include information regarding existing accounts the giftor has with those third-party retailers. Exemplary packaging parameters may include gift wrapping options for the items in the target gift set, or the inclusion of a gift receipt with the shipment, thereby permitting the giftee to return the item to the source retailer if they desire. Gift accessory parameter may include, for example, an option to accompany items in the target gift set with a card, balloons, flowers, candy or possibly another smaller gift. Some payment parameters may include, for example, a payment method option (e.g., PayPal®, layaway, etc.), or timing of the payment.

A giftor may determine (i.e., setup) the acquisition preference set through an interface to the gifting system 100 that allows a giftor to create or modify parameters in the acquisition preference set. Such an interface may be implemented by the gift fulfillment module 106. For some embodiments, the acquisition preference set may be stored on, and subsequently retrieved from, a local database or datastore coupled to the gifting system 100.

For some embodiments, the gift fulfillment module 106 may be further configured to handle situations where one or more items within the target gift set are currently unavailable at the time of order, or one or more items are unable to be acquired such that they will be received by the giftee in a timely fashion (e.g., on or before the gift-receiving occasion). At times, such situations may be the result of the acquisition preference set being enforced in the acquisition of the items in the target gift set. In such cases, the gift fulfillment module 106 may notify the giftor of the situation and upon giftor's approval, ignore some or all of the acquisition preference set (e.g., purchase item from a non-preferred retailer).

At other times, the unavailability of items or the inability to acquire items in a timely manner may be the result of supplier issues (e.g., retailer's inability to ship on time, or lack of inventory by all possible retailers). In instances such as these, the gift fulfillment module 106 may return to the gift scanning module 104 to identify the next gift selection subset, from the gift selection set, that best meets/fits the gift criterion set determined by the giftor.

In various embodiments, the gifting system 100 may be configured to send notifications to giftees and giftors regarding processes being performed in the gifting system 100. For example, the gift selection module 102 may send notification to a giftee (e.g., via e-mail, or phone call) after sets of gift selections and gift ranks have been successfully imported from gift registries and wish lists maintained by a third party on behalf of the giftee. In another example, the gift selection module 104 may be configured to notify a giftor when it has commenced scanning for gifts for a giftee in anticipation of an upcoming gift-giving occasion (e.g., birthday, anniversary, etc.). In yet another example, the gift scanning module 106 may be configured to send a notification to a giftor updating him or her on the fulfillment status of items in the target gift set (e.g., items have been ordered, from whom the items have been ordered, items have shipped, or items have delivered).

Additionally, upon successful fulfillment of one or more items within the target gift set, the gifting system 100 may be configured to update the gift selection set (e.g., the gift fulfillment module 106 or the gift selection module 102 removes successfully fulfilled items from the gift selection set) upon confirmation of fulfillment (e.g., confirmation from a fulfillment system to the gift fulfillment module 106 that the item has been ordered or delivered). For some embodiments, where some or all of the items in the gift selection set are imported from a third-party gift registry or wish list, updates to the gift selection set (e.g., by the gift selection module 102 or the gift fulfillment module 106) may result in updates to the third-party gift registry or wish list. For example, where an item in the gift selection set is removed by the gift fulfillment module 106 from the gift selection set upon fulfillment (e.g., successful order or delivery), such removal may be similarly applied to the gift registry or wish list from which the item was originally imported.

Those skilled in the art will understand and appreciate that the gifting system 100 is no way limited to the scenario where a single giftor is gifting a single giftee, and that various gifting systems described herein may be configured to handle where a single giftor may gift a group of giftees, a group of giftors may gift a group of giftees, and a group of giftors may gift a single giftee.

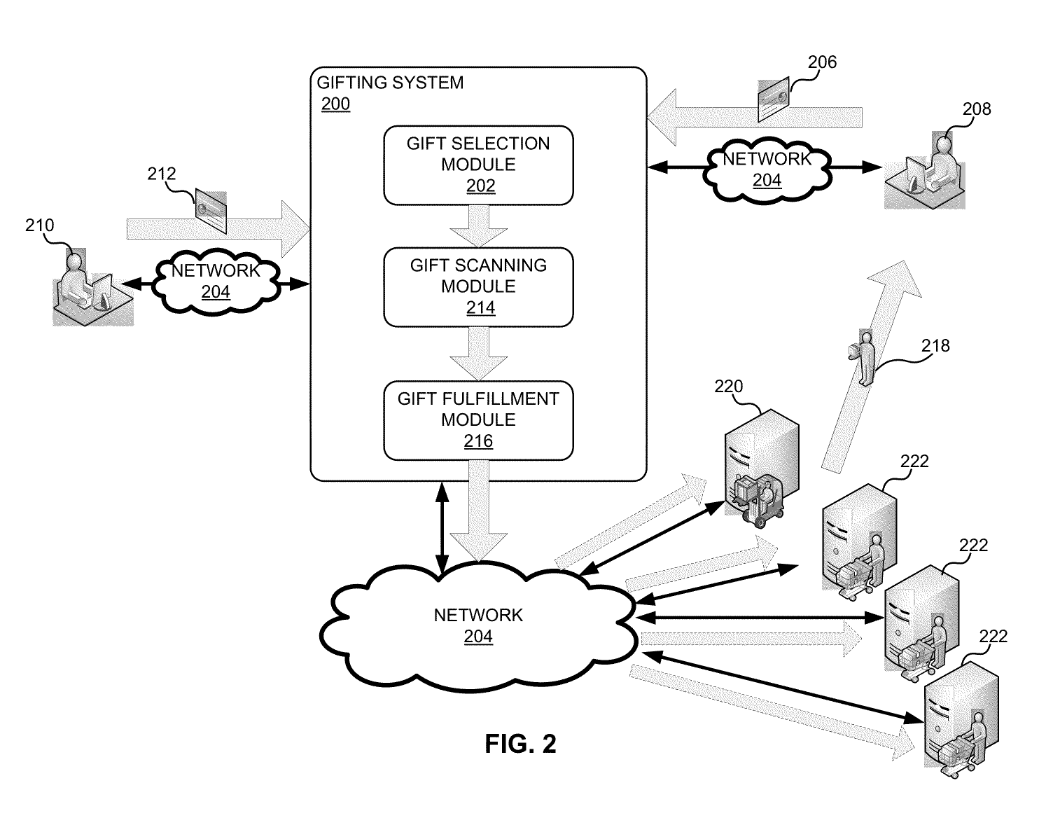

FIG. 2 depicts an exemplary system 200 for targeted gifting in accordance with some embodiments. The gifting system 200 comprises a gift selection module 202, a gift scanning module 214, and a gift fulfillment module 216. For some embodiments, the gift selection module 202, the gift scanning module 214, and the gift fulfillment module 216 may be similar in function and/or operation to modules of FIG. 1 that are similarly named (i.e., the gift selection module 102, the gift scanning module 104, and the gift fulfillment module 106, respectively). Through a network 204, the gifting system 200 may be configured to interact with a giftee 208, a giftor 210, a fulfillment system 220 associated with the operator of the gifting system 202 (e.g., associated with the operator's own warehouse/store), or fulfillment systems 222 of third-party retailers.

The gift selection module 202 may receive a gift selection set, as determined by the giftee 208. The gift selection module 202 may also receive a gift rank set associated with, and accompanying the gift selection set. As noted herein, the gift selection set may include products, services, or donations (to recognized charities) in the name of the giftee. As also noted herein, the gift selection set may be imported from gift registries and wish lists a giftee has setup with a third-party, such as third-party retailer (e.g., wedding registry with Crate and Barrel®). In some embodiments, the gift selection module 202 may enable the giftee to 208 directly create and modify a gift selection set through a gift selection interface 206, which may be implemented as a web page accessible by the giftee 208 over the network 204 (e.g., Internet). The gift rank set associated with the gift selection set may be inherent to the gift selection set received by the gift selection module 202 (e.g., rank based on order of items), or may be maintained as a separate set of numerical values that designate the importance of corresponding gift selections in the gift selection set.

The gift scanning module 214 may receive a gift criterion set, as determined by the giftor 210. As described herein, the gift criterion set may include such criteria as a budget, a product manufacturer, a product model, a product category, a retailer, or a shipping option. In various embodiments, the gift scanning module 214 may enable the giftor 210 to create and modify a gift criterion set through a gift selection interface 212, which may be implemented as a web page accessible by the giftor 210 over the network 204 (e.g., Internet).

Using the gift selection set, the gift rank set, and the gift criterion set, the gift scanning module 214 may be configured to select a target gift set from the gift selection set based on the gift rank set and the gift criterion set. As noted herein, the target gift set may comprise a subset of items from the gift selection set.

Upon selection of the target gift set, the gift fulfillment module 216 may acquire each item in the target gift set through generation and submission of purchase orders to one or more fulfillment systems. In some embodiments, the gift fulfillment module 216 may generate and submit purchase order in accordance with an acquisition preference set determined by the giftor 210. Additionally, for some embodiments, the gift fulfillment module 216 may enable the giftor 210 to create and modify a set of acquisition preference through a preference interface, which may be implemented as a web page accessible by the giftor 210 over the network 204.

In various embodiments, the gift fulfillment module 216 may be configured to generate and route orders to one or more fulfillment systems, over the network 204, according to the acquisition preference set, and based on availability of the items with particular suppliers (e.g., the operator's own warehouse/store or a third-party retailer). Take for instance where the gift fulfillment module 216 determines that a first subset of items in the target gift set are available at the operator's own warehouse/store, and determines that a second subset of the remaining items in the target gift set are available at third-party retailers. In such a situation, the gift fulfillment module 216 may generate and submit an order for the first subset of items to the fulfillment system 220 associated with the operator's own warehouse/store, and generate and submit an order for the second subset of items to the various fulfillment systems 222 of third-party retailers (e.g., Amazon®, Barnes and Noble®, or Target®).

Once orders from the gift fulfillment module 216 are received and processed by the fulfillment systems 220 or 222, a delivery service 218 may be utilized to deliver ordered items to the giftee 208 on behalf of the giftor 210. Alternatively, where the acquisition preference set indicates that the giftor 210 prefers to receive the order items (e.g., so that he or she can personally deliver the items to the giftee 208), the gift fulfillment module 216 may generate and submit orders to the fulfillment systems 220 or 222 accordingly. In instances where the item ordered is a donation made by the giftor on behalf of the giftee, the delivery service 218 may be utilized deliver confirmation or notification of the donation to the giftee, possibly by postal mail or electronically (e.g., e-mail).

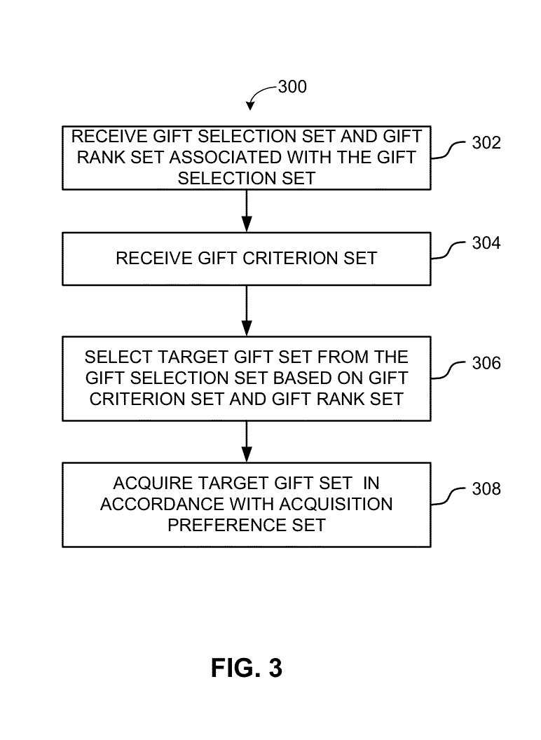

FIG. 3 depicts a flowchart illustrating an exemplary method 300 for targeted gifting in accordance with some embodiments. With reference to the gifting system 100 of FIG. 1, at step 302, the gift selection module 102 receives a gift selection set, and a gift rank set associated with the gift selection set. As described herein, the gift selection set may be associated with a giftee, an upcoming gift-giving occasion, or both (e.g., associated with a particular giftee in connection with a particular gift-giving occasion). In some embodiments, the gifting system 100 may initially receive the gift selection set and a gift rank set using a web interface (e.g., implemented by the gift selection module 102) that permits a giftee to create and modify the two sets, or may be imported from a gift registry or wish list maintained by a third-party (e.g., online retailer). Once the gifting system 100 receives the gift selection set and gift rank set, they may be stored in a local database or datastore coupled to the gifting system 100, and later retrieved by the gift selection module 102 to determine a target gift set for the giftee. Accordingly, the gift selection module 102 may receive the gift selection set and the gift rank set from the local database or datastore.

At step 304, the gift scanning module 104 receives a gift criterion set as determined by a giftor. In some embodiments, the gifting system 100 may receive the gift criterion set using a web interface (e.g., implemented by the gift scanning module 104) that permits the giftor to create and modify the gift criterion set. Once entered into the gifting system 100, the gift criterion set may be stored in a local database or datastore coupled to the gifting system 100, and later retrieved by the gift scanning module 104 to determine the target gift set for the giftee. As such, the gift scanning module 104 may receive the gift criterion set from the local database or datastore.

At step 306, the gift scanning module 104 selects the target gift set from the gift selection set based on the gift criterion set and gift rank set. Additionally, depending on the embodiment, the selection process may involve (a) filtering the gift selection set first using the gift ranks and then the gift criterion set, or (b) using a scoring scheme, in which gift selection subsets (which can include one gift selection) from the gift selection set are assigned a score based on the gift rank of their individual items and based on how well the subset meets the gift criterion set.

At step 308, the gift fulfillment module 106 acquires each item in the target gift set for the giftee on behalf of the giftor, which may be in accordance with the acquisition preference set determined by the giftor. In some embodiments, the gifting system 100 may receive the acquisition preference set using a web interface (e.g., implemented by the gift fulfillment module 106) that permits the giftor to create and modify the acquisition preference set. Additionally, in some embodiments, the gift acquisition process may involve the gift fulfillment module 106 generating purchase orders for items in the target gift set and submitting such purchase order to one or more fulfillment systems, which may be associated with the operator of the gifting system 100 (e.g., operator's own warehouse/store) or with a third-party retailer.

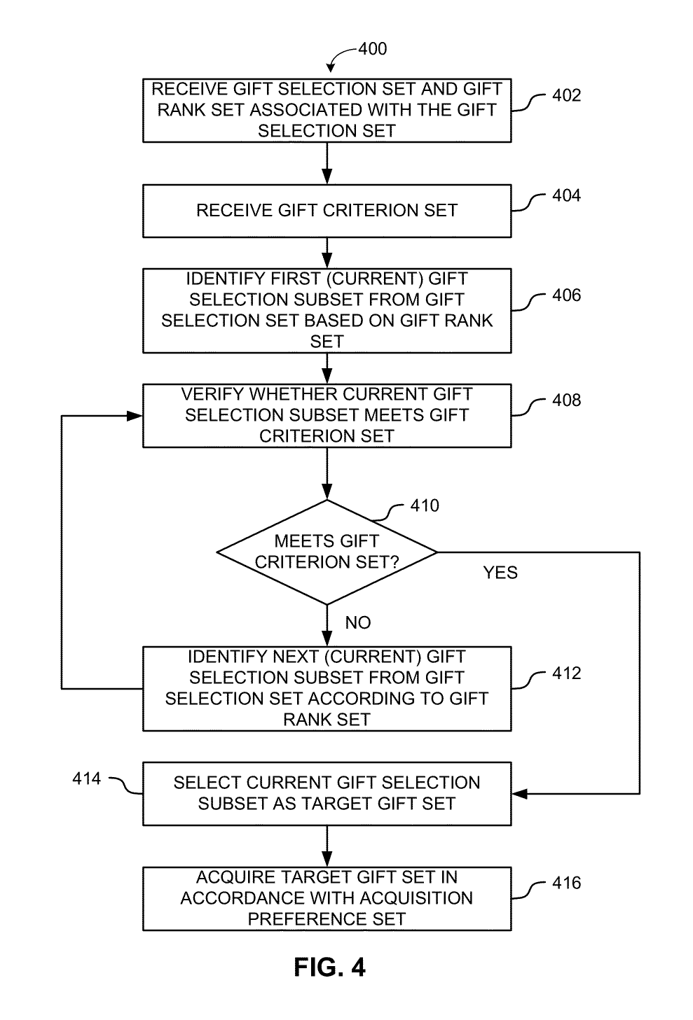

FIG. 4 depicts a flowchart illustrating an exemplary method 400 for targeted gifting in accordance with some embodiments. With continued reference to the gifting system 100 of FIG. 1, at step 402, the gift selection module 102 receives a gift selection set, and a gift rank set associated with the gift selection set. As described herein, the gift selection set may be associated with a giftee, an upcoming gift-giving occasion, or both (e.g., associated with a particular giftee in connection with a particular gift-giving occasion). In some embodiments, the gifting system 100 may initially receive the gift selection set and a gift rank set using a web interface (e.g., implemented by the gift selection module 102) that permits a giftee to create and modify the two sets, or may be imported from a gift registry or wish list maintained by a third-party (e.g., online retailer). Once the gifting system 100 receives the gift selection set and gift rank set, they may be stored in a local database or datastore coupled to the gifting system 100, and later retrieved by the gift selection module 102 to determine a target gift set for the giftee. Accordingly, the gift selection module 102 may receive the gift selection set and the gift rank set from the local database or datastore.

At step 404, the gift scanning module 104 receives a gift criterion set as determined by a giftor. In some embodiments, the gifting system 100 may receive the gift criterion set using a web interface (e.g., implemented by the gift scanning module 104) that permits the giftor to create and modify the gift criterion set. Once entered into the gifting system 100, the gift criterion set may be stored in a local database or datastore coupled to the gifting system 100, and later retrieved by the gift scanning module 104 to determine the target gift set for the giftee. As such, the gift scanning module 104 may receive the gift criterion set from the local database or datastore.

At step 406, the gift scanning module 104 identifies from the gift selection set a first, current gift selection subset. In some embodiments, the first gift selection subset is identified based on the gift rank set provided in step 402. For example, the first gift selection subset identified may contain the top 10 gift selections from the gift selection set.

At step 408, the gift scanning module 104 verifies whether the current gift selection subset meets (or at least how well it meets) the gift criterion set received at step 404. For instance, where the gift criterion set indicates that the giftor's budget is $100 and that at least 20% of the budget should be utilized, a current gift selection subset totaling $90 would meet the gift criterion set. In the same instance, if a current gift selection subset totaled $75 or $110, such a subset would be deemed to not meet the gift criterion set. Depending on the preceding step, the current gift selection subset may be the first gift selection subset identified in step 406, or the next gift selection subset identified in step 410.

At step 410, if the gift scanning module 104 determines that the current gift selection subset meets the gift criterion set (or meets it well enough), the gift scanning module 104 eventually selects the current gift selection subset as the target gift set at 414.

If at step 410 the gift scanning module 104 determines otherwise, at step 412 the gift scanning module 104 identifies from the gift selection set a next, current gift selection subset. As with step 406, in some embodiments, the next gift selection subset is identified based on the gift rank set provided in step 402. In addition, in some embodiments, the gift scanning module 104 may adjust the identification process to narrow or widen the range of gift ranks sought from the gift selection set. For instance, the gift scanning module 104 may adjust the identification process to such that it identifies the top 20, rather than the top 10, gift selections from the gift selection set, which may possibly improve the likelihood of the current subset meeting the gift criterion set.

Subsequent to step 412, the method 400 returns to step 408, where the gift scanning module 104 verifies whether the next current gift selection subset meets (or at least how well it meets) the gift criterion set received at step 404. After step 408, the method 400 continues to step 410 as described herein.

At step 416, the gift fulfillment module 106 acquires each item in the target gift set for the giftee on behalf of the giftor, which may be in accordance with the acquisition preference set determined by the giftor. In some embodiments, the gifting system 100 may receive the acquisition preference set using a web interface (e.g., implemented by the gift fulfillment module 106) that permits the giftor to create and modify the acquisition preference set. Additionally, in some embodiments, the gift acquisition process may involve the gift fulfillment module 106 generating purchase orders for items in the target gift set and submitting such purchase order to one or more fulfillment systems, which may be associated with the operator of the gifting system 100 (e.g., operator's own warehouse/store) or with a third-party retailer.

FIG. 5 depicts a flowchart illustrating an exemplary method 500 for targeted gifting using a scoring scheme, and FIG. 6 depicts an outcome for performance of such an exemplary method. The following describes the method 500 with reference to the gifting system 100 of FIG. 1 and with reference to the outcome depicted in FIG. 6.

At step 502, the gift selection module 102 receives a gift selection set, and a gift rank set associated with the gift selection set. As described herein, the gift selection set may be associated with a giftee, an upcoming gift-giving occasion, or both (e.g., associated with a particular giftee in connection with a particular gift-giving occasion). In some embodiments, the gifting system 100 may initially receive the gift selection set and a gift rank set using a web interface (e.g., implemented by the gift selection module 102) that permits a giftee to create and modify the two sets, or may be imported from a gift registry or wish list maintained by a third-party (e.g., online retailer). Once the gifting system 100 receives the gift selection set and gift rank set, they may be stored in a local database or datastore coupled to the gifting system 100, and later retrieved by the gift selection module 102 to determine a target gift set for the giftee. Accordingly, the gift selection module 102 may receive the gift selection set and the gift rank set from the local database or datastore.

At step 504, the gift scanning module 104 receives a gift criterion set as determined by a giftor. In some embodiments, the gifting system 100 may receive the gift criterion set using a web interface (e.g., implemented by the gift scanning module 104) that permits the giftor to create and modify the gift criterion set. Once entered into the gifting system 100, the gift criterion set may be stored in a local database or datastore coupled to the gifting system 100, and later retrieved by the gift scanning module 104 to determine the target gift set for the giftee. As such, the gift scanning module 104 may receive the gift criterion set from the local database or datastore.

At step 506, the gift scanning module 104 identifies one or more gift selection subsets from the gift selection set. Depending on the embodiment, the gift scanning module 104 may identify some or all possible gift selection subsets from the gift selection set that have a unique combination of items. In the example of chart 600 in FIG. 6, a gift selection set 614 is shown with three gift selection subsets 604, 606, and 608 being identified therefrom. As shown, the subset 604 includes items 610 and 618, the subset 606 includes item 612, and the subset 608 includes items 616 and 620.

At step 508, the gift scanning module 104 determines a rank score for each gift selection subset identified by the gift scanning module 104 in step 506. In some embodiments, the gift scanning module 104 may determine the rank score for a given gift selection subset by first determining a rank score for each item in the gift selection subset, and then using the sum of those rank scores as the overall rank score for the gift selection subset. Alternatively, in some embodiments, the gift scanning module 104 may determine the rank score of a gift selection subset to be the rank score for the item in the gift selection subset having the highest rank. The rank score for each item in a gift selection subset may be determined according to a rank score mapping, which assigns a predetermined rank score (e.g., numeric value) for a given rank. As described herein, for some embodiments, the rank of a given item within a gift selection subset may be determined according to that item's ordinal position in the gift selection set, from which the subset originates.

For example, in context of FIG. 6, the rank score of each item in the subsets 604, 606, and 608 may be determined according to rank score mapping 602 and the item's ordinal position in the gift selection set 614. Accordingly, the item 610 may have a rank score of 10, the item 608 may have a rank score of 3, the item 612 may have a rank score of 8, the item 616 may have a rank score of 5, and the item 610 may have a rank score of 3. As such, for those embodiments that use the sum of item rank scores to determine a subset rank score, the gift scanning module 104 may assign the subset 604 a rank score of 13, the subset 606 a rank score of 8, and the subset 608 a rank score of 9.

Alternatively, in those embodiments that assign use the highest item rank score as the subset rank score, the gift scanning module 104 may assign the subset 604 a rank score of 10, the subset 606 a rank score of 8, and the subset 608 a rank score of 6. These scores are reflected in field 624 of FIG. 6.

At step 510, the gift scanning module 104 determines a criterion score for each gift selection subset, identified by the gift scanning module 104 in step 506, based on the gift criterion set received at step 504. In some embodiments, the verification of a given gift selection subset with each criterion in the gift criterion set may result in a separate criterion score for that criterion as applied to the given subset. As such, the criterion score for a given gift selection subset may be determined by summing together the individual criterion scores produced from verifying the given subset against a gift criterion set. Additionally, in some embodiments, the criterion score associated with a given criterion may be determined by summing the individual criterion scores determined for each item in the given gift selection subset. Each criterion score may be calculated based on whether an entire gift selection subset or a single item in the gift selection subset meets a criterion from the set of criteria, or based on how well the entire gift selection subset or the single item meets a criterion from the set of criteria.

For instance, where the gift criterion set indicates a budget of $200 and a preference for products manufactured by Sony®, and an item has a price of $150 and is manufactured by Apple®, the gift scanning module 104 may assign a criterion score of 7.5 for utilizing 75% of the budget and a criterion score of 0 (or value less than zero) for the mismatch in manufacturer. If this item were the only item in a given gift selection subset, the given subset would be assigned a criterion score of 7.5.

In the context of FIG. 6, the gift criterion set applied to the gift selection subsets 604, 606, and 608 include a budget of $500. With respect to this budget, the gift scanning module 104 may assign a criterion score for each of the subsets 604, 606, and 608 according to the following formula:

$$Subset Criterion Score = \frac{\% of Budget Used}{10} .$$

Based on this formula, the gift scanning module 104 may assign a criterion score of 3 for the subset 604, a criterion score of 9.6 for the subset 606, and a criterion score of 10 for the subset 608. These scores are reflected in field 622 of FIG. 6.

In some embodiments, the gift criterion set may be configured with a criterion that results in a negative criterion score when a target gift set has over a specific number of items. In doing so, some such embodiments may ensure, for example, that an item that uses more of the budget has a higher likelihood of being in the target gift set than multiple items that in aggregate make equal or better use of the budget. Take for instance where the budget is set at $500, a first gift selection subset contains a single item from the gift selection set worth $490, and a second gift selection subset contains six items from the gift selection set that in aggregate are worth $495. In some embodiments, the gift criterion set may be configured with a criterion that would assess a negative criterion score to a gift selection subset having more than four items, thereby giving the first gift selection subset a higher likelihood of being the target gift set than the second gift selection subset, despite the higher worth.

At step 512, the gift scanning module selects a subset from the gift selection subsets to be the target gift set. In some embodiments, the subset selected has an associated rank score and an associated criterion score that results in an optimal score (e.g., highest score in comparison to those of all other gift selection subsets). Depending on the embodiment, the optimal score may be the highest or the lowest score achieved by any of the subsets, based on the summation of a rank score and a criterion score (i.e., a total subset score). For example, in the case of FIG. 6, the total subset score for the subset 604 is 13, the total subset score for the subset 606 is 17.6, and the total subset score for subset 608 is 16. These scores are reflected in field 626. As such, based on the understanding that the highest score is the optimal score, the gift scanning module 104 may select the subset 606 as the target gift set for having the optimal score.

At step 514, the gift fulfillment module 106 acquires each item in the target gift set for the giftee on behalf of the giftor, which may be in accordance with the acquisition preference set determined by the giftor. In some embodiments, the gifting system 100 may receive the acquisition preference set using a web interface (e.g., implemented by the gift fulfillment module 106) that permits the giftor to create and modify the acquisition preference set. Additionally, in some embodiments, the gift acquisition process may involve the gift fulfillment module 106 generating purchase orders for items in the target gift set and submitting such purchase order to one or more fulfillment systems, which may be associated with the operator of the gifting system 100 (e.g., operator's own warehouse/store) or with a third-party retailer.

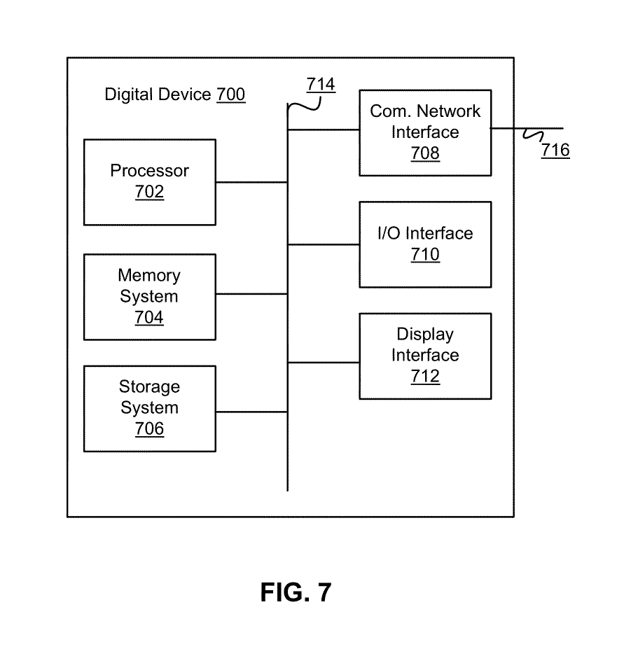

FIG. 7 is a block diagram of an exemplary digital device 702. Any of the gifting systems (e.g., 100 and 200), devices used by giftors and giftees to interact with the gifting systems, and the fulfillment systems (e.g., 220 and 222) that interact with the gifting systems may be an instance of the digital device 702. Digital devices may include, without limitation, desktops/laptops, servers, mobile phones, tablets or other computing devices that are embedded in an appliance (e.g., network enabled refrigerator with touch screen) or embedded in a vehicle (e.g., in-car audio, video, and/or navigation system). The digital device 702 comprises a processor 704, memory system 706, storage system 708, an input device 710, a communication network interface 712, and an output device 714 communicatively coupled to a communication channel 716. The processor 704 is configured to execute executable instructions (e.g., programs). In some embodiments, the processor 704 comprises circuitry or any processor capable of processing the executable instructions.

The memory system 706 stores data. Some examples of memory system 706 include storage devices, such as RAM, ROM, RAM cache, virtual memory, etc. In various embodiments, working data is stored within the memory system 706. The data within the memory system 706 may be cleared or ultimately transferred to the storage system 708.

The storage system 708 includes any storage configured to retrieve and store data. Some examples of the storage system 708 include flash drives, hard drives, optical drives, and/or magnetic tape. Each of the memory system 706 and the storage system 708 comprises a computer-readable medium, which stores instructions or programs executable by processor 704.

The input device 710 is any device such an interface that receives inputs data (e.g., via mouse and keyboard). The output device 714 is an interface that outputs data (e.g., to a speaker or display). Those skilled in the art will appreciate that the storage system 708, input device 710, and output device 714 may be optional. For example, the routers/switchers may comprise the processor 704 and memory system 706 as well as a device to receive and output data (e.g., the communication network interface 712 and/or the output device 714).

The communication network interface (com. network interface) 712 may be coupled to a network (e.g., network 204) via the link 718. The communication network interface 712 may support communication over an Ethernet connection, a serial connection, a parallel connection, and/or an ATA connection. The communication network interface 712 may also support wireless communication (e.g., 802.11a/b/g/n, WiMax, LTE, WiFi). It will be apparent to those skilled in the art that the communication network interface 712 can support many wired and wireless standards.

It will be appreciated by those skilled in the art that the hardware elements of the digital device 702 are not limited to those depicted in FIG. 7. A digital device 702 may comprise more or less hardware, software and/or firmware components than those depicted (e.g., drivers, operating systems, touch screens, biometric analyzers, etc.). Further, hardware elements may share functionality and still be within various embodiments described herein. In one example, encoding and/or decoding may be performed by the processor 704 and/or a co-processor located on a GPU (i.e., NVidia®).

The above-described functions and components can be comprised of instructions that are stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with some embodiments. Those skilled in the art are familiar with instructions, processor(s), and storage medium.

As used herein, the term “set” may refer to any collection of elements, whether finite or infinite. The term subset may refer to any collection of elements, wherein the elements are taken from a parent set; a subset may be the entire parent set. The term proper subset refers to a subset containing fewer elements than the parent set.

Additionally, it will be appreciated that a “module” may comprise software, hardware, firmware, and/or circuitry. In one example one or more software programs comprising instructions capable of being executable by a processor may perform one or more of the functions of the modules described herein. In another example, circuitry may perform the same or similar functions. Alternative embodiments may comprise more, less, or functionally equivalent modules and still be within the scope of present embodiments. For example, the functions of the various modules may be combined or divided differently.

Unless otherwise stated, use of the word “about” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Various embodiments are described herein as examples. It will be apparent to those skilled in the art that various modifications may be made and other embodiments can be used without departing from the broader scope of the present invention. Therefore, these and other variations upon the exemplary embodiments are intended to be covered by the present invention(s).

What is claimed is:

1. A method for targeted gifting, comprising:
receiving, at a computer system, a gift selection set and a gift rank set associated with the gift selection set, wherein each gift rank in the gift rank set corresponds to at least one gift selection in the gift selection set, and each gift rank in the gift rank set indicates a preference for the respective gift selections in the gift selection set;
receiving a gift criterion set of a giftor;
selecting a target gift set from the gift selection set based on the gift criterion set and the gift rank set; and
assisting in fulfilling a gift selection in the target gift set for a gift recipient on behalf of the giftor.

2. The method of claim 1, wherein assisting in fulfilling the gift selection is in accordance with an acquisition preference set of the giftor.

3. The method of claim 1, wherein selecting the target gift set comprises:
identifying a first gift selection subset from the gift selection set based on the gift rank set;
verifying whether the first gift selection subset meets the gift criterion set; and
if the first gift selection subset meets the gift criterion set, selecting the first gift selection subset as the target gift set.

4. The method of claim 3, wherein selecting the target gift set further comprises:
if the first gift selection subset fails to meet the gift criterion set, identifying a next gift selection subset from the gift selection set based on the gift rank set, and verifying whether the next gift selection subset meets the gift criterion set.

5. The method of claim 4, wherein identifying and verifying another gift selection subset are repeated until a gift selection subset meets the gift criterion set or all unique subset combinations for the gift selection set are exhausted.

6. The method of claim 3, wherein a gift selection in the first gift selection subset meets a gift criterion of the gift criterion set if the gift selection falls within a range based on the gift criterion.

7. The method of claim 6, wherein where the gift criterion is a budget, an upper limit of the range is equal to the budget, and a lower limit of the range is a value less than the budget.

8. The method of claim 7, wherein the lower limit is between about 80 and about 85% of the budget.

9. The method of claim 1, wherein selecting the target gift set comprises:
identifying one or more subsets of the gift selections from the gift selection set;
determining a rank score for each gift selection subset based on the gift rank set;
determining a criterion score for each gift selection subset if the gift selection subset meets the gift criterion set; and
identifying a gift selection subset, from the gift selection subsets, having a rank score and a criterion score that result in an optimal score.

10. The method of claim 1, wherein selecting the target gift set is performed at a predetermined time in advance of a particular occasion associated with the gift recipient.

11. The method of claim 1, wherein the gift selection set or the gift criterion set is associated with a particular gift recipient, a plurality of gift recipients, a particular occasion, or a plurality of occasions.

12. The method of claim 1, wherein the gift criterion set includes a budget.

13. The method of claim 1, wherein the gift criterion set includes a product manufacturer, a product model, a product category, a retailer, or a shipping option.

14. The method of claim 2, wherein the acquisition preference set includes a shipment parameter, a retailer parameter, a packaging parameter, a gift accessory parameter, or a payment parameter.

15. The method of claim 1, wherein the gift selection set is imported at least in part from a third-party gift registry or a third-party gift wish list.

16. A system for targeted gifting, comprising:
a gift selection module, operating on a computer system, configured to receive a gift selection set and a gift rank set associated with the gift selection set, wherein each gift rank in the gift rank set corresponds to at least one gift selection in the gift selection set, and each gift rank in the gift rank set indicates a preference for the respective gift selections in the gift selection set;
a gift scanning module configured to:
receive a gift criterion set of a giftor, and
select a target gift set from the gift selection set based on the gift criterion set and the gift rank set; and
a gift fulfillment module configured to assist in fulfilling a gift selection in the target gift set for a gift recipient on behalf of the giftor.

17. The system of claim 16, wherein the gift fulfillment module is configured to assist in fulfilling the gift selection in accordance with an acquisition preference set of the giftor.

18. The system of claim 16, wherein the gift scanning module is configured to select the target gift set by:
identifying a first gift selection subset from the gift selection set based on the gift rank set;
verifying whether the first gift selection subset meets the gift criterion set; and
if the first gift selection subset meets the gift criterion set, selecting the first gift selection subset as the target gift set.

19. The system of claim 18, wherein the gift scanning module is further configured to select the target gift set by:
if the first gift selection subset fails to meet the gift criterion set, identifying a next gift selection subset from the gift selection set based on the gift rank set, and verifying whether the next gift selection subset meets the gift criterion set.

20. The system of claim 19, wherein identifying and verifying another gift selection subset are repeated until a gift selection subset meets the gift criterion set or all unique subset combinations for the gift selection set are exhausted.

21. The system of claim 18, wherein a gift selection in the first gift selection subset meets a gift criterion of the gift criterion set if the gift selection falls within a range based on the gift criterion.

22. The system of claim 21, wherein where the gift criterion is a budget, an upper limit of the range is equal to the budget, and a lower limit of the range is a value less than the budget.

23. The system of claim 22, wherein the lower limit is between about 80 and about 85% of the budget.

24. The system of claim 16, wherein the gift scanning module is configured to select the target gift set by:
identifying one or more subsets of the gift selections from the gift selection set;
determining a rank score for each gift selection subset based on the gift rank set;
determining a criterion score for each gift selection subset if the gift selection subset meets the gift criterion set; and
selecting a target gift set, from the gift selection subsets, having a rank score and a criterion score that result in an optimal score.

25. The system of claim 16, wherein the gift scanning module is configured to select the target gift set at a predetermined time in advance of a particular occasion associated with the gift recipient.

26. The system of claim 16, wherein the gift selection set or the gift criterion set is associated with a particular gift recipient, a plurality of gift recipients, a particular occasion, or a plurality of occasions.

27. The system of claim 16, wherein the gift criterion set includes a budget.

28. The system of claim 16, wherein the gift criterion set includes a product manufacturer, a product model, a product category, a retailer, or a shipping option.

29. The system of claim 17, wherein the acquisition preference set includes a shipment parameter, a retailer parameter, a packaging parameter, a gift accessory parameter, or a payment parameter.

30. The system of claim 16, wherein the gift selection set is imported at least in part from a third-party gift registry or a third-party gift wish list.

31. A system for targeted gift giving, comprising:
means for receiving a gift selection set and a gift rank set associated with the gift selection set, wherein each gift rank in the gift rank set corresponds to at least one gift selection in the gift selection set, and each gift rank in the gift rank set indicates a preference for the respect gift selections in the gift selection set;
means for receiving a gift criterion set of a giftor;
means for selecting a target gift set from the gift selection set based on the gift criterion set and the gift rank set; and
means for assisting in fulfilling a gift selection in the target gift set for a gift recipient on behalf of the giftor.
